(19) United States
(12) Patent Application Publication
(10) Pub. No.: US 2022/0380029 A1
(43) Pub. Date: Dec. 1, 2022

(54) SELF PROPELLED THRUST-PRODUCING CONTROLLED MOMENT GYROSCOPE

(71) Applicant: Airborne Motor Works Inc., Veradale, WA (US)

(72) Inventors: Jesse Antoine Marcel, Veradale, WA (US); Jeffrey Scott Chimenti, The Woodlands, TX (US)

(21) Appl. No.: 17/743,420

(22) Filed: May 12, 2022

Related U.S. Application Data
(63) Continuation of application No. 16/368,653, filed on Mar. 28, 2019, now abandoned.
(60) Provisional application No. 62/649,097, filed on Mar. 28, 2018.

(51) Int. Cl. B64C 27/02; B64C 17/06

(52) U.S. Cl. CPC B64C 27/027; B64C 17/06; B64C 27/028

(57) ABSTRACT

The present invention comprises a novel propulsion method and apparatus for personal air vehicles generally consisting of gyroscopic movable assembly containing a gyroscope flywheel that produces thrust. In a preferred embodiment the gyroscope is hubless. The gyroscope flywheel integrates permanent magnets along its perimeter ring while spokes with an airfoil cross-section and positive incidence angle create airflow when rotated. The spokes couple the gyroscope's perimeter ring with a smaller central hubless ring. Proximate to the gyroscope's flywheel is an electromagnet fixed assembly that produces phasing electromagnetic fields that rotate the gyroscopic movable assembly. The invention comprises a self-contained apparatus with no external motor because the assembly is a motor with a self-stabilizing gyroscope that produces directional airflow that can be used to propel air, land and sea vehicles.

### PRIORITY CLAIM

This application is a continuation of U.S. patent application Ser. No. 16/368,653 filed Mar. 28, 2019; which claims the benefit of priority from U.S. Provisional Patent Application No. 62/649,097 filed Mar. 28, 2018, the contents of which are incorporated by reference.

### FIELD OF THE INVENTION

The present invention relates generally to propulsion methods used to create thrust for propelling aircraft. More specifically, the invention relates to a self-contained propulsion system consisting of an electric, preferably hubless gyroscope that produces thrust while creating balance and stability.

### BACKGROUND OF THE INVENTION

Electric aircraft propulsion systems create thrust by connecting an electric motor to an auxiliary means composed of propellers/rotors either directly or through a driveshaft and/or gearbox to the motors output shaft. While these methods can provide adequate thrust when correctly sized for their applications, they have less efficiency than a self-contained propulsion system. A second drawback is the propulsion methods innate instability requiring an offsetting means to keep the vehicle stable.

Therefore, a need exists in the field of electric aircraft propulsion systems for a self-contained apparatus with no external motor because the assembly is a motor with a self-stabilizing gyroscope that produces directional airflow that can be used to propel personal air vehicles.

### SUMMARY OF THE INVENTION

The subject invention comprises a method and apparatus for propelling Electric Personal Air Vehicles both efficiently and safely. The invention employs a preferably controlled moment hubless gyroscope flywheel with spokes that are shaped to provide directed airflow when rotated. The spokes couple the perimeter of the gyrosope's flywheel ring with an unsupported central ring. The periphery of the gyroscope's flywheel contains magnets that are acted upon by proximate stationary electromagnets that create a multi-phase magnetic field. The gyroscope's flywheel is peripherally supported by a plurality of rolling element bearings with sheaves. The present invention is a self-contained apparatus with no external motor because the assembly is a motor with a self-stabilizing gyroscope that produces directional airflow that can be used to propel personal air vehicles.

### BRIEF DESCRIPTION OF THE DRAWINGS

These and other features and advantages of the present invention will become more readily appreciated as the same becomes better understood by reference to the following detailed description. Preferred and alternative examples of the present invention are described in detail below with reference to the following drawings.

FIG. 1 depicts an exploded view example of an electric thrust-producing controlled moment hubless gyroscope according to various embodiments of the present invention.

FIG. 2 illustrates a top view example of a flywheel according to various embodiments described herein.

FIG. 3 shows a side view example of a lower magnet retaining ring with inferior bearing couple removed, according to various embodiments described herein.

FIG. 4 depicts an example side illustration of a removable bearing couple that also serves as a mechanism to lock a plurality of magnets in place against the perimeter of the gyroscope's flywheel.

FIG. 5 depicts a perspective view of a flywheel according to various embodiments of the present invention.

FIG. 6 shows a side view of rolling element bearings and bearing sheaves according to various embodiments of the present inventions.

FIG. 7 shows a top view of rolling element bearings and bearing sheaves proximate to upper ring bearing couple according to various embodiments of the present invention.

FIG. 8 depicts a cross-section of the present invention according to various embodiments of the present invention.

FIG. 9 shows a top view of a stator according to various embodiments of the present invention.

FIG. 10 depicts stator fingers with proximate coils according to various embodiments of the present invention.

FIG. 11 shows a side profile of a stator according to various embodiments of the present invention.

FIG. 12 depicts a top view section of a shell support according to various embodiments of the present invention.

FIG. 13 depicts a perspective view of a shell support assembly for an electric thrust-producing gyroscope according to various embodiments of the present invention.

FIG. 14 illustrates upper exterior shell and intake component according to various embodiments of the present invention.

FIG. 15 illustrates an upper exterior shell and intake duct assembly according to various embodiments of the present invention.

FIG. 16 depicts lower exterior shell and exhaust duct components according to various embodiments of the present invention.

FIG. 17 depicts lower exterior shell assembly and exhaust duct according to various embodiments of the present invention.

FIG. 18 illustrates a perspective view example of an electric thrust-producing controlled moment gyroscope according to various embodiments of the present invention.

FIG. 19 illustrates a block diagram of a motor controller device that serves to govern in a predetermined manner the performance according to various embodiments of the present invention.

### DETAILED DESCRIPTION OF THE PREFERRED EMBODIMENT

The terminology used herein is for describing particular embodiments only and is not intended to be limiting for the invention. As used herein, the term “and/or” includes any and all combinations of one or more of the associated listed items. As used herein, the singular forms “a,” “an” and “the” are intended to include the plural forms as well as the singular forms, unless the context clearly indicates otherwise. It will be further understood that the terms “comprises” and/or ‘comprising’ when used in this specification, specify the presence of stated features, steps, operations, elements, and/or components, but do not preclude the addition of one or more other features, steps, operations, elements, components, and/or groups thereof.

Unless otherwise defined, all terms used herein, including technical and scientific terms, used herein have the same meaning as commonly understood by one having ordinary skill in the art to which the invention belongs. It will be further understood that terms, such as those defined in commonly used dictionaries, should be interpreted as having a meaning that is consistent with their meaning in the one context of the relevant art and the present disclosure and will not be interpreted in an idealized or overly formal sense unless expressly so defined, herein. In describing the invention, it will be understood that several techniques and steps are disclosed. Each of these has individual benefit and each can also be used in conjunction with one or more (or in some cases all) of the other disclosed techniques. Accordingly, for the sake of clarity, this description will refrain from repeating every possible combination of the individual steps in an unnecessary fashion. Nevertheless, the specification and claims should be read with the understanding that such combination are entirely within the scope of the invention and the claims.

New thrust-producing controlled moment gyroscope devices, apparatuses, and methods for creating a self-leveling, stable and efficient propulsion system are discussed herein. In the following description, for the purposes of explanation, numerous specific details are set forth in order to provide a thorough understanding of the present invention. It will be evident, however, to one skilled in the art that the present invention may be practiced without these specific details. The present disclosure is to be considered as an exemplification of the invention and is not intended to limit the invention to the specific embodiments illustrated by the figures or description below.

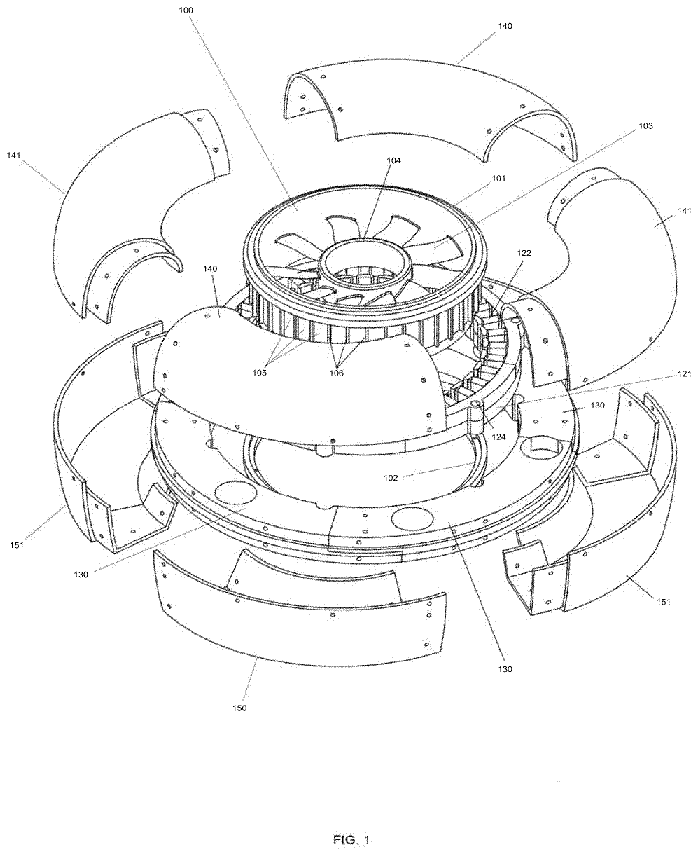

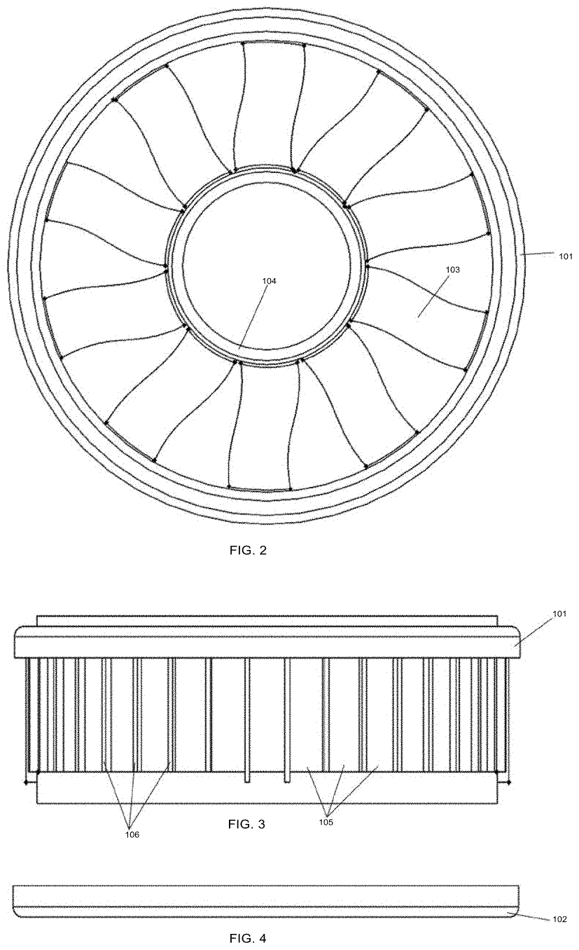

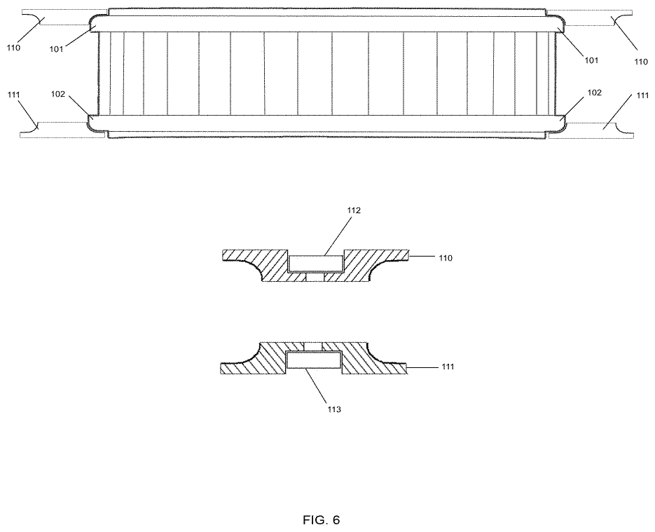

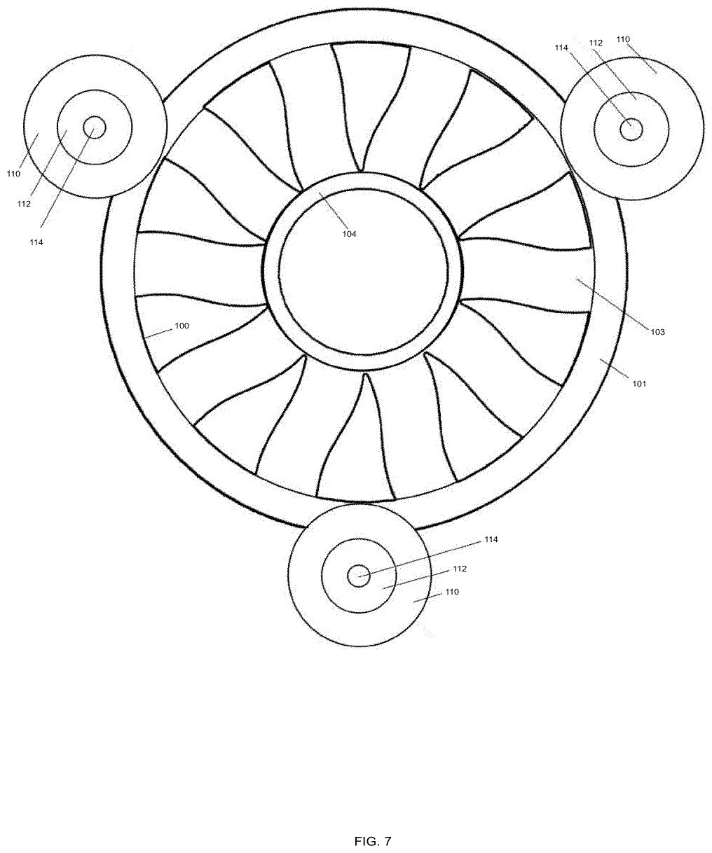

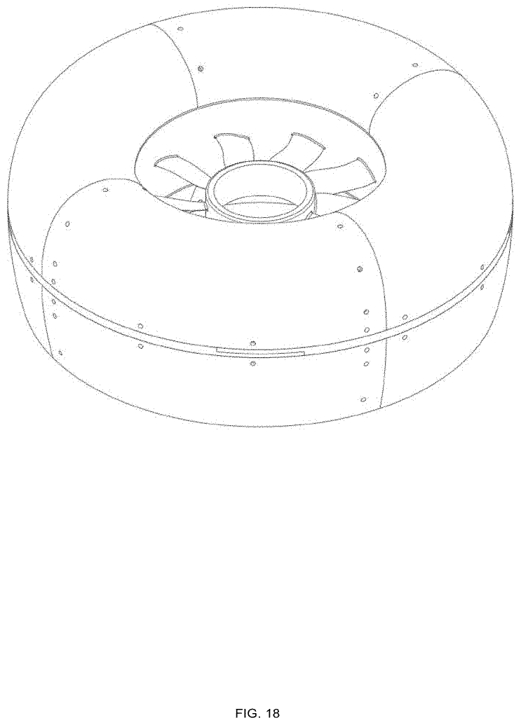

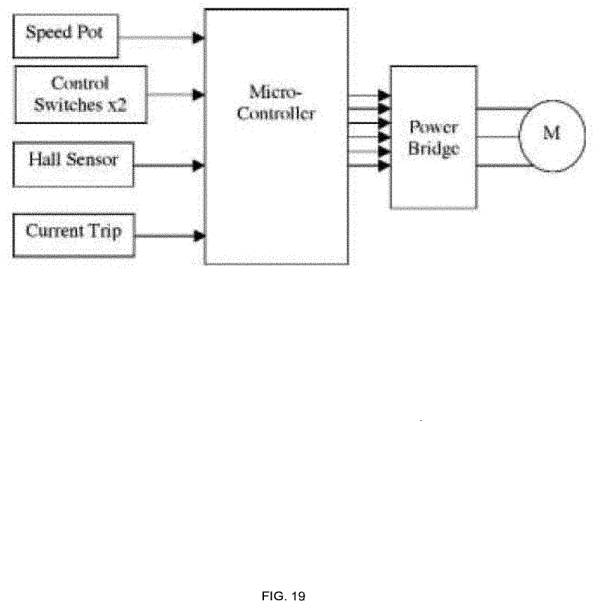

The present invention will now be described by referencing the appended figures representing preferred and alternative embodiments. FIG. 1 depicts an exploded view of the elements that may comprise a thrust-producing gyroscope device (the “device”) according to various embodiments of the present invention. In preferred embodiments, the general assembly FIG. 18 contains each of the elements of the device configured with at least one central gyroscope flywheel peripheral ring 100, as shown in FIG. 5, which may be made of lightweight composite materials, aluminum, or another suitable material. The ring 100 is configured to accept a plurality of magnets 105 along the gyroscope's exterior perimeter located between superior bearing couple 101 and removable inferior bearing couple 102 locking the magnets in place. Vertical protrusions separate the magnets when necessary to split the surface area of the gyroscope's perimeter equally. In an alternate embodiment the gyroscope flywheel all or in part is composed of magnetic field producing elements, for example made of composite fabrics, neodymium particles, copper, or another suitable material embedded into its composite structure.

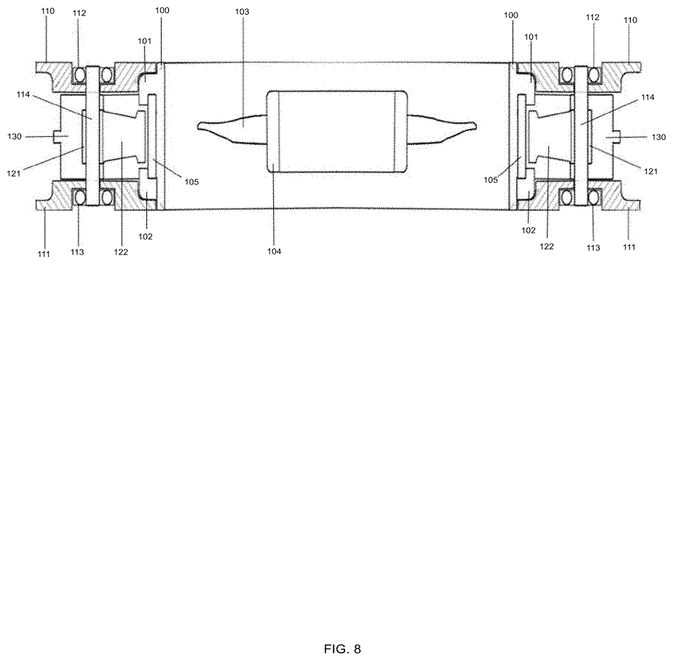

In the preferred embodiment the gyroscope's flywheel is supported by integrated bearing couple 101 as shown in FIG. 8, along with removable bearing couple 102. A plurality of spokes 103 couple the gyroscope rotors peripheral ring 100 with central circular hub 104, which may be made of lightweight composite materials, aluminum, or another suitable material. The gyroscope's flywheel spokes 103, which may be made of lightweight composite materials, aluminum, or another suitable material, have a cross-section and positive incidence angle to create desired airflow. In an alternate embodiment, the gyroscope flywheel shown in FIG. 5 is supported by hub 104 attached to a central axle.

As shown with reference to FIG. 8, the present invention includes a plurality of rolling element bearings upper 112 and lower 113 with sheaves 110, 111, which may be made of lightweight composite materials, aluminum, or another suitable material, and allow the rotation of the gyroscope flywheel and transmission of thrust to the surrounding static assemblies. When the gyroscope is rotated it's spokes produce thrust while the gyroscope's flywheel maintains orientation. The faster the revolutions of the gyroscope's flywheel, the greater the thrust and gyroscopic effect.

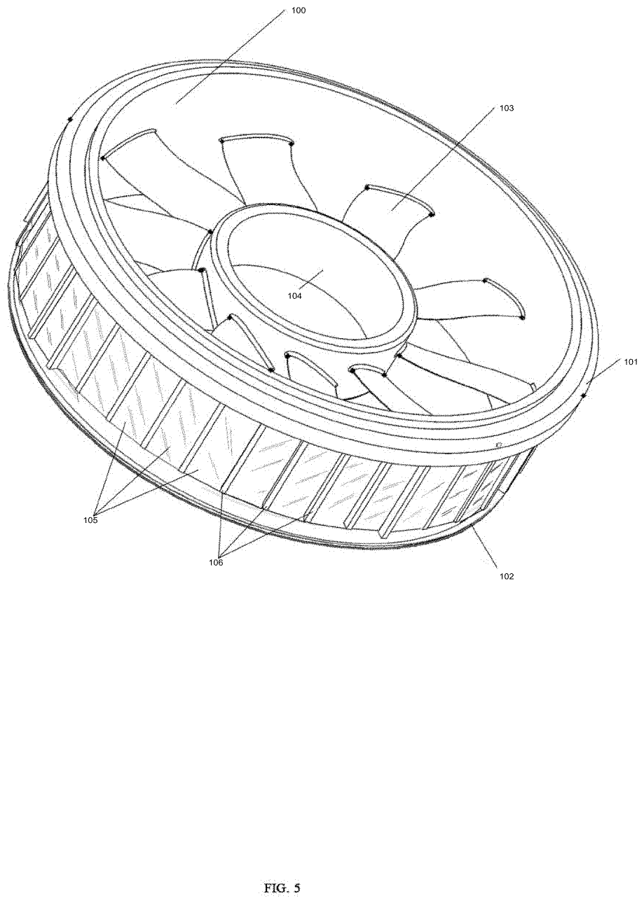

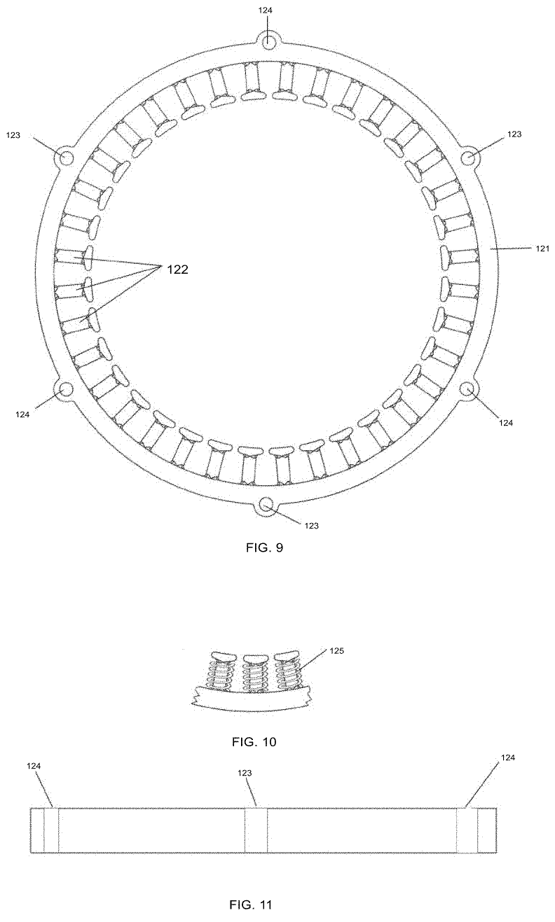

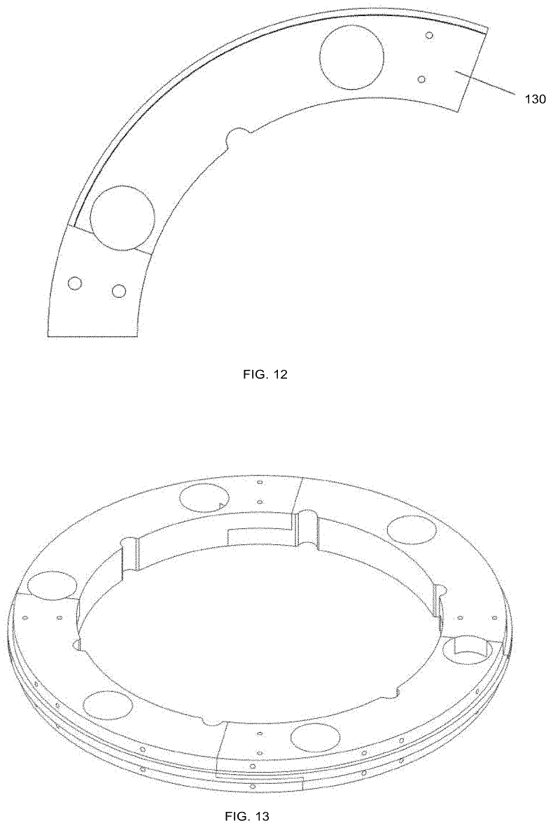

As shown with reference to FIG. 9, proximate to the gyroscope flywheel is stator 121, which may be made of lightweight composite materials, iron, or another suitable material. As shown with reference to FIG. 10, the fingers of the stator 121 are individually wrapped by insulated wire coils 122, which may be made of lightweight composite materials, copper, or another suitable material. As shown with reference to FIG. 19, the individual coils are wired together in such manner to create a multi-phase electromagnet governed by motor controller 135. In an alternate embodiment, the bodywork or shell surrounding the magnetic gyroscope produces phasing magnetic fields replacing the preferred embodiments stator assembly and the shell is manufactured with a network of electrically conductive materials integrated into its composite matrix or along the shell surface. In an alternate embodiment, as shown with reference to FIG. 4, magnets are located on or in hub 104 with a multi-phase magnetic field producing stator proximate to the hub's magnets to cause rotation. As shown with reference to FIGS. 8 and 9, in a preferred embodiment, a plurality of penetrations located in stator perimeter 123 supports a plurality of rods 114 that locate a plurality of rolling element bearings 112,113 with a plurality of sheaves 110, 111.

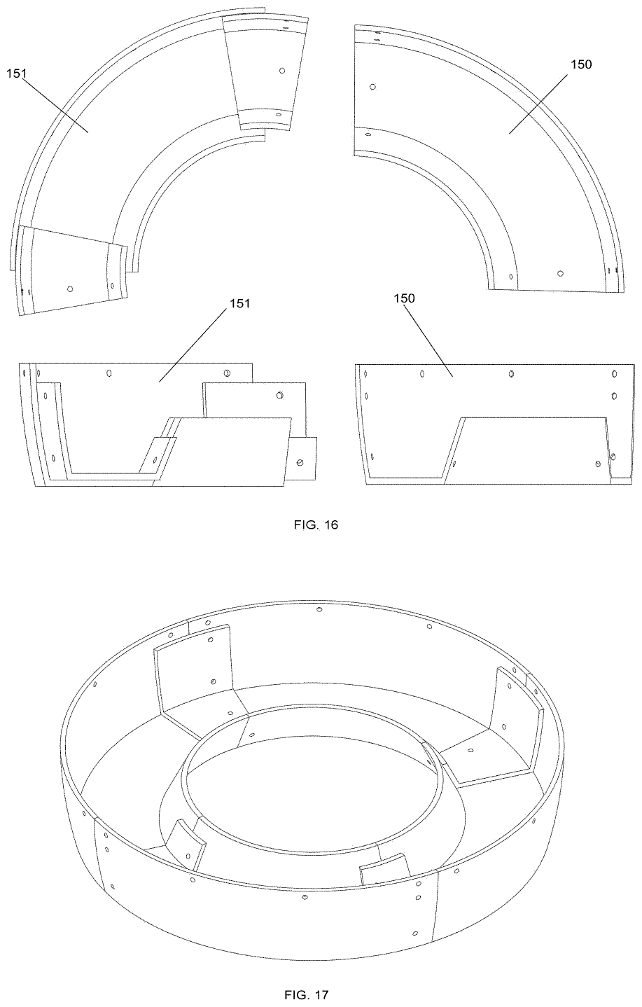

Enveloping the gyroscope's flywheel and stator assemblies FIG. 8 is exterior upper shell FIG. 15 constructed from a plurality of upper shell components 140, 141, as shown in FIG. 14, which may be made of lightweight composite materials, aluminum, or another suitable material. As shown with reference to FIG. 1, the components direct air into the gyroscope spokes 103 while protecting the invention from external impact with foreign objects.

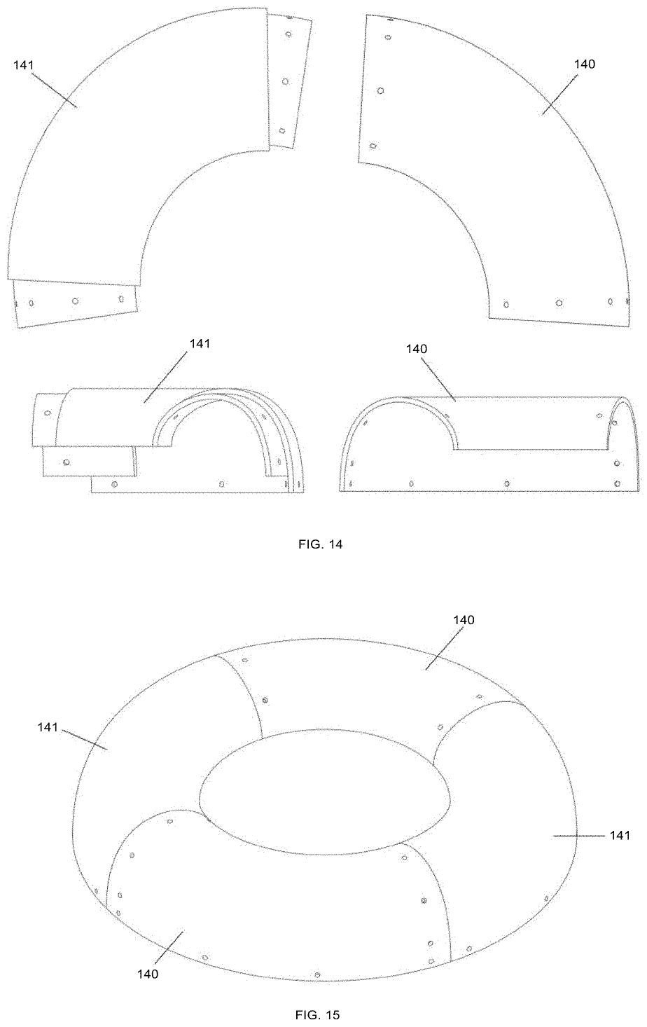

The exterior lower shell shown in FIG. 17 is preferably constructed from a plurality of lower shell components 150, 151, shown with reference to FIG. 16, may be made of lightweight composite materials, aluminum, or another suitable material and is used to direct air out of the electric thrust-producing gyroscope and protect the invention from external impact with foreign objects. The upper exterior shell shown in FIG. 15 and lower exterior shell shown in FIG. 17 is coupled to stator 121, shown with reference to FIG. 9, with shell support assembly 130, shown with reference to FIG. 13, preferably constructed from a plurality of shell support components 130, which may be made of lightweight composite materials, aluminum, or another suitable material. As shown with reference to FIG. 9, the shell support assembly attaches to the stator 121 with bolts attached through a plurality of penetrations 124. In an alternate embodiment, glue of sufficient strength or interlocking surfaces replace all or some of the bolts used in the construction of the general assembly FIG. 18.

In an alternate embodiment, the gyroscope's flywheel is powered by a jet turbine.

In yet an alternate embodiment, the flywheel is powered by an internal combustion engine.

In an alternate embodiment the self-propelled thrust-producing controlled moment hubless gyroscope method and apparatus can be used to power air, land and sea vehicles.

In an alternate embodiment the self-propelled thrust-producing controlled moment hubless gyroscope method and apparatus can be used to power commercial, professional, and recreational unmanned aerial vehicles.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A self-propelled hubless gyroscope, comprising:
a flywheel having a first magnetic field
a second magnetic field proximate to the flywheel, wherein the interaction between the first and second magnetic fields causes the flywheel to rotate and level the orientation of the gyroscope; and
a plurality of spokes connecting a perimeter of the flywheel to a centrally located ring, wherein the spokes create directional air flow as the flywheel rotates to produce thrust.

2. The gyroscope of claim 1, wherein the flywheel is composed at least in part of magnetic field producing elements that form the first magnetic field.

3. The gyroscope of claim 1, wherein the first magnetic field is formed elements that create the first magnetic field are at least one magnet mounted peripherally to the flywheel.

4. The gyroscope of claim 1, further comprising a stator mounted proximate to the flywheel for producing phased magnetic fields.

5. The gyroscope of claim 2, wherein:
the stator is comprised of fingers that are individually wrapped by insulated wire coils; and
the individual coils are wired together to create a multi-phase electromagnet.

6. The gyroscope of claim 1, further comprising a shell surrounding the flywheel having a network of electrically conductive materials integrated into at least one of its composite matrix or surface to produce phasing magnetic fields.

7. A self-propelled hubless gyroscope, comprising:
a flywheel having a first magnetic field
a second magnetic field proximate to the flywheel, wherein the interaction between the first and second magnetic fields causes the flywheel to rotate and level the orientation of the gyroscope;
a stator mounted proximate to the flywheel for producing phased magnetic fields; and
a plurality of spokes connecting a perimeter of the flywheel to a centrally located ring, wherein the spokes create directional air flow as the flywheel rotates to produce thrust.

8. The gyroscope of claim 7, wherein the flywheel is composed at least in part of magnetic field producing elements that form the first magnetic field.

9. The gyroscope of claim 7, wherein the first magnetic field is formed elements that create the first magnetic field are at least one magnet mounted peripherally to the flywheel.
